(19) United States
(12) Patent Application Publication
(10) Pub. No.: US 2011/0132046 A1
(43) Pub. Date: Jun. 9, 2011

(54) LOCK, PARTICULARLY FOR SUITCASES, TRUNKS AND THE LIKE

(76) Inventor: Massimo Tonelli, Casalecchio Di Reno (IT)

(21) Appl. No.: 12/737,788

(22) PCT Filed: Aug. 29, 2008
(86) PCT No.: PCT/IT2008/000565

§ 371 Date: Feb. 16, 2011

(51) Int. Cl. E05B 65/52; B65D 51/00

(52) U.S. Cl. 70/69; 292/307 B

(57) ABSTRACT

A lock, particularly for suitcases and trunks, comprising at least one clamp which is articulated with a first end, to a first half-shell of a suitcase and can rotate from a closure configuration of the suitcase, in which a lip that protrudes from the clamp abuts elastically against a protrusion formed along a second half-shell of the suitcase, to fasten the first half-shell to the second half-shell, to an opening configuration of the suitcase, in which the lip is disengaged from the protrusion, and vice versa. The lock comprises an arm, articulated to the clamp and having, at a first end portion thereof, a curved tab. The tab engages elastically by interlocking with the protrusion at the closure configuration, in order to reinforce the fastening of the first half-shell to the second half-shell. The arm can be operated manually to disengage the tab from the protrusion, independently of the clamp.

The present invention relates to a lock, particularly for suitcases, trunks and the like.

### BACKGROUND OF THE INVENTION

As is known, the use of portable containers, such as bags or suitcases, constituted by two mutually articulated half-shells having respective rims which, in the closure configuration and by way of the action of one or more locks, are pressed against each other so as to provide a hermetic seal against the unwanted infiltration of water or other impurities, is currently widespread.

With particular reference to some professional uses, such hermetic seal must be assuredly maintained in order to preserve the contents even in case of violent shocks and impacts, such as those caused by a fall, which in traditional suitcases might cause accidental opening.

In order to give the desired resistance to impacts, it is therefore common to resort to constructively complicated locks, with components whose surfaces and thicknesses are considerable.

Accordingly, these locks are not easy to handle and are scarcely practical, since considerable manual effort is required in order to produce their release.

This same Applicant is the proprietor of Italian Patent applications No. BO2004A000455 and No. BO2006A000358, which disclose embodiments that solve at least partially the drawbacks cited above.

They in fact resort to means for the quick release of a clamp that is designed to fasten the two half-shells: such means are, for example, a lever which is hinged to the clamp and can be operated manually to move it into abutment against the clamp and release it, allowing the opening of the container.

Even these constructive solutions, however, are not free from drawbacks.

To ensure tightness even following accidental falls and impacts, the sizing of the elements involved increases considerably the value of the force to be applied to the lever in order to overcome the contrast torque (which in turn is necessary in order to ensure impact resistance).

Again, therefore, opening the lock is awkward and difficult to accomplish.

### SUMMARY OF THE INVENTION

The aim of the present invention is to solve the above-mentioned drawbacks, by providing a lock that is capable of combining practicality and easy manual opening with preservation of the closure and hermetic seal even following accidental actions such as impacts or falls.

Within this aim, an object of the invention is to provide a lock that is suitable for application to any type of portable container.

Another object of the invention is to provide a lock that ensures high reliability in operation.

Another object of the invention is to provide a lock that can be obtained easily starting from commonly commercially available elements and materials.

Another object of the invention is to provide a lock that has a low cost and is safe in application.

This aim and these and other objects that will become better apparent hereinafter are achieved by a lock, particularly for suitcases, trunks and the like, comprising at least one clamp which is articulated, substantially with a first end, to a first half-shell of a suitcase, said clamp being able to rotate from a suitcase closure configuration, in which a lip that protrudes from said clamp abuts elastically against a protrusion formed along a second half-shell of the suitcase, to fasten said first half-shell to said second half-shell, to a suitcase opening configuration, in which said lip is disengaged from said protrusion, and vice versa, characterized in that it comprises an arm which is articulated to said clamp and has, at a first end portion thereof, a curved tab that can engage elastically by interlocking with said protrusion at said closure configuration, in order to reinforce the fastening of said first half-shell on said second half-shell, said arm being manually actuatable to disengage said tab from said protrusion, independently of said clamp.

### BRIEF DESCRIPTION OF THE DRAWINGS

Further characteristics and advantages of the invention will become better apparent from the following detailed description of five preferred but not exclusive embodiments of the lock according to the invention, illustrated by way of non-limiting example in the accompanying drawings, wherein:

FIG. 1 is an exploded perspective view of the lock according to the invention in the first embodiment;

FIGS. 2 to 6 are views of the lock according to the invention, applied to a suitcase, in the second embodiment, and more particularly:

FIG. 2 is a front elevation view of the lock according to the invention, in the opening configuration;

FIG. 3 is a sectional view of FIG. 2, taken along the line

FIG. 4 is a highly enlarged-scale view of a detail of FIG. 3;

FIG. 5 is the same sectional view as FIG. 3, with the lock in the closure configuration;

FIG. 6 is a highly enlarged-scale view of a detail of FIG. 5;

FIG. 7 is a view of the lock according to the invention in the third embodiment, and more particularly shows the same detail as FIG. 4, with the lock in the opening configuration;

FIGS. 8 to 12 are views of the lock according to the invention, applied to a suitcase, in the fourth embodiment, and more particularly:

FIG. 8 is a front elevation view of the lock according to the invention, in the opening configuration;

FIG. 9 is a sectional view of FIG. 8, taken along the line IX-IX;

FIG. 10 is a highly enlarged-scale view of a detail of FIG. 9;

FIG. 11 is the same sectional view as FIG. 9, with the lock in the closure configuration;

FIG. 12 is a highly enlarged-scale view of a detail of FIG. 11;

FIG. 13 is a view of the lock according to the invention in the fifth embodiment, and more particularly shows the same detail as FIG. 10, with the lock in the opening configuration.

### DESCRIPTION OF THE PREFERRED EMBODIMENTS

With reference to the figures, a lock according to the invention, generally designated by the reference numeral 1, comprises at least one clamp 2, which is articulated, substantially with a first end 2a, to a first half-shell 3 of a suitcase 4.

It should be specified from the outset that the suitcase 4 can be of any type or size; equivalently, the locks 1 according to the invention can be provided on a trunk or equally on other types of portable container.

The clamp 2 can rotate, about an articulation rod 5 that is associated with the first half-shell 3, from a configuration for closure of the suitcase 4 to a configuration for opening it, and vice versa.

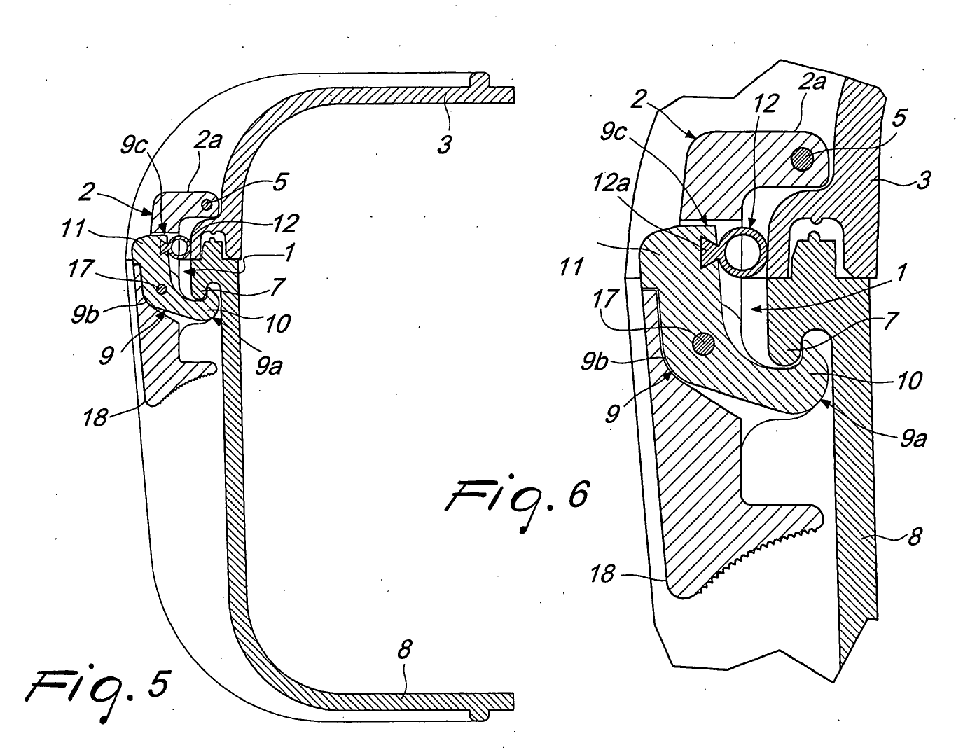

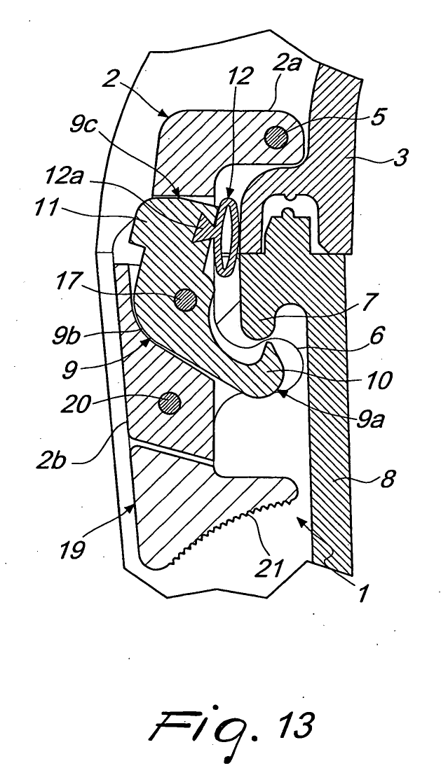

More specifically, in the closure configuration, shown in FIGS. 5, 6, 11 and 12, a lip 6, which protrudes from the clamp 2, abuts elastically against a protrusion 7, which is formed along a second half-shell 8 of the suitcase 4, in order to fasten the first half-shell 3 to the second half-shell 8.

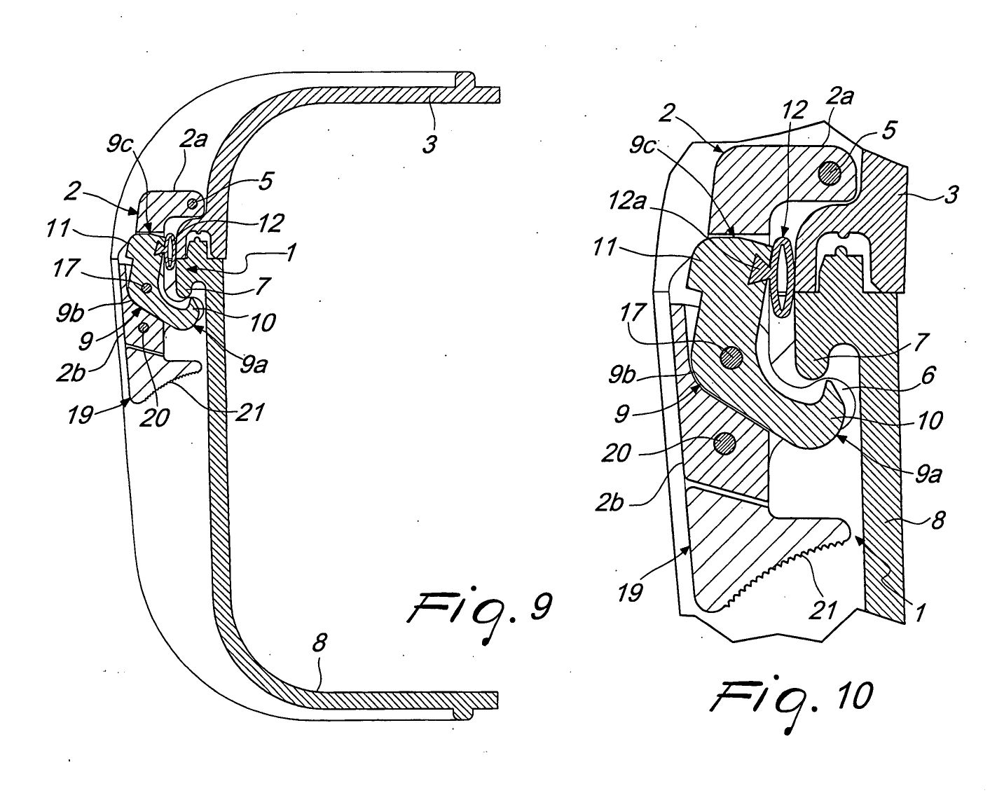

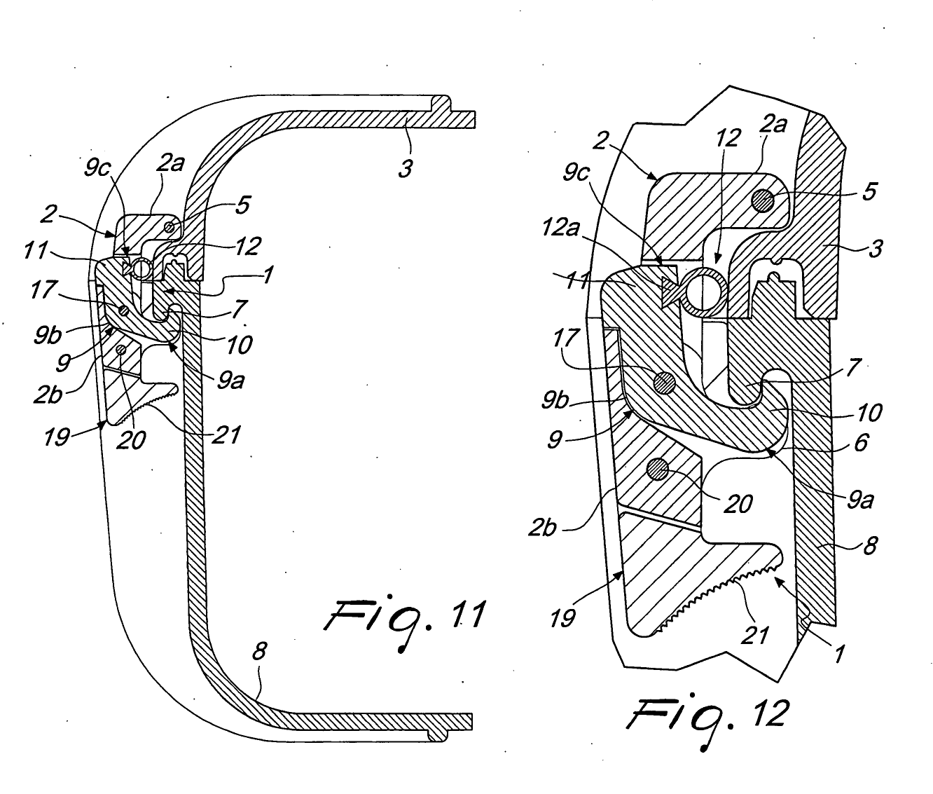

In the opening configuration, shown for example in FIGS. 3, 4, 9, and 10, the lip 6 is disengaged from the protrusion 7, in order to allow the rotation of the first half-shell 3 on the second half-shell 8 (or vice versa) and therefore allow access to the content of the suitcase 4.

The suitcase 4, according to the embodiment shown in the accompanying figures by way of non-limiting example of the application of the invention, is in fact constituted by the first half-shell 3 and by the second half-shell 8, which are mutually articulated in two or more hinges and are kept in mutual contact, in the closure configuration, by one or more locks 1 and by the respective clamps 2.

According to the invention, the lock 1 comprises an arm 9, which is articulated to the clamp 2 and has, proximate to a first end portion 9a thereof, a curved tab 10, for example of the type of a tooth.

The tab 10 engages elastically by interlocking the protrusion 7 at the closure configuration of the suitcase 4, thus reinforcing the fastening of the first half-shell 3 on the second half-shell 8, in order to prevent the accidental release of the lock 1 as a consequence of shocks or collisions.

The arm 9 can be operated manually to allow the disengagement of the tab 10 from the protrusion 7 independently of the clamp 2, thus keeping the suitcase 4 in the closure configuration ensured by the action of the clamp 2.

In particular, the arm 9 is articulated to the clamp 2 at a central portion 9b thereof, and its second end portion 9c, which lies opposite the first one, is substantially shaped like a button 11.

An elastically deformable element 12 is interposed between the button 11 and the first half-shell 3: the elastic reaction of the element 12, which acts on the arm 9 at the button 11, makes the tab 10 engage automatically the protrusion 7 at the closure configuration.

In order to disengage the tab 10 from the protrusion 7, it is sufficient to apply a slight external pressure to the button 11, on the opposite side with respect to the element 12, in order to compress the latter elastically, contrasting and thus overcoming its elastic reaction and causing the rotation of the arm 9 about its central portion 9b.

According to an embodiment of particular practical interest, shown in the accompanying figures by way of non-limiting example of the application of the invention, the elastically deformable element 12 is substantially a spring.

Said spring has a protrusion 12a which is shaped complementarily with respect to a receptacle formed on the second end portion 9c in order to fix it thereto.

More particularly, as is particularly evident for example from FIG. 3, the fixing of the spring to the arm 9 is ensured by the substantially dovetail shape of the protrusion 12a, which duplicates the shape of the receptacle in which it is accommodated.

According to an alternative embodiment, the arm 9 has, at the second end portion 9c, a protrusion made of elastically deformable material, which faces the first half-shell 3 and constitutes the elastically deformable element 12.

This embodiment allows to minimize the number of components in the bill of materials needed to provide the lock 1 according to the invention and therefore to reduce the risk of breakage or jamming due to malfunctions. The possibility is in fact considered to provide the arm 9, already equipped with said protrusion, by means of a single co-molding process, without therefore requiring the step for fixing the spring, which is necessary for the embodiment described earlier.

For example, it is possible to make the arm 9 of plastic material and the tab 10 also of plastic material or metal alloys such as zinc-aluminum-manganese alloy.

As can be seen in particular from FIG. 1, at least the central region of the clamp 2 is provided with two lateral ribs 13, which delimit a central recess 14, which in turn forms a seat for the arm 9.

Above the recess 14, the clamp 2 has a slot 15 in which the button 11 is accommodated.

According to the embodiment shown in the accompanying figures, and shown in particular in FIGS. 5, 6, 11 and 12, in the closure configuration the top of the button 11 is substantially aligned with the profile of the clamp 2: in this manner, the button 11 does not protrude outside the clamp 2, avoiding the risk of accidental actuation of the arm 9 as a consequence of impacts against the lock 1 and the clamp 2. A different sizing can instead be provided in order to allow the button 11 to protrude only slightly from the profile of the clamp 2, to allow easy pressing even while wearing work gloves, while avoiding projection beyond the protrusions that are typically provided on the outside of the suitcases 4 and trunks of the professional type.

Two holes 16 for receiving a first pivot 17 that passes through the central portion 9b of the arm 9 to allow its articulation to the clamp 2 are provided along the ribs 13.

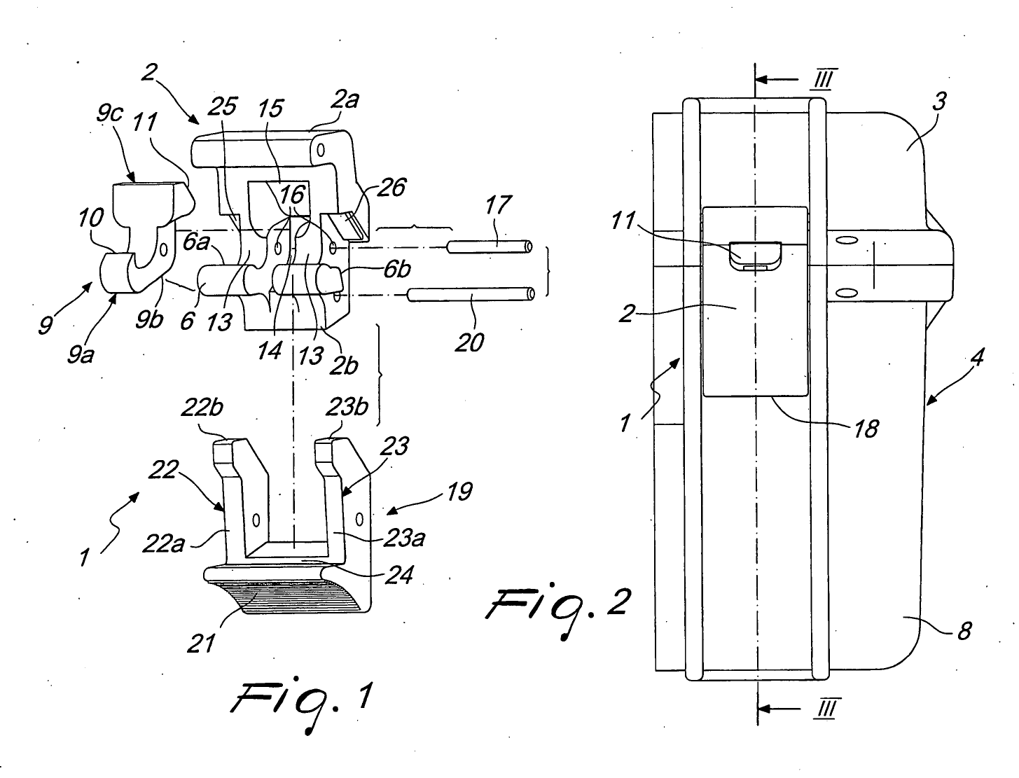

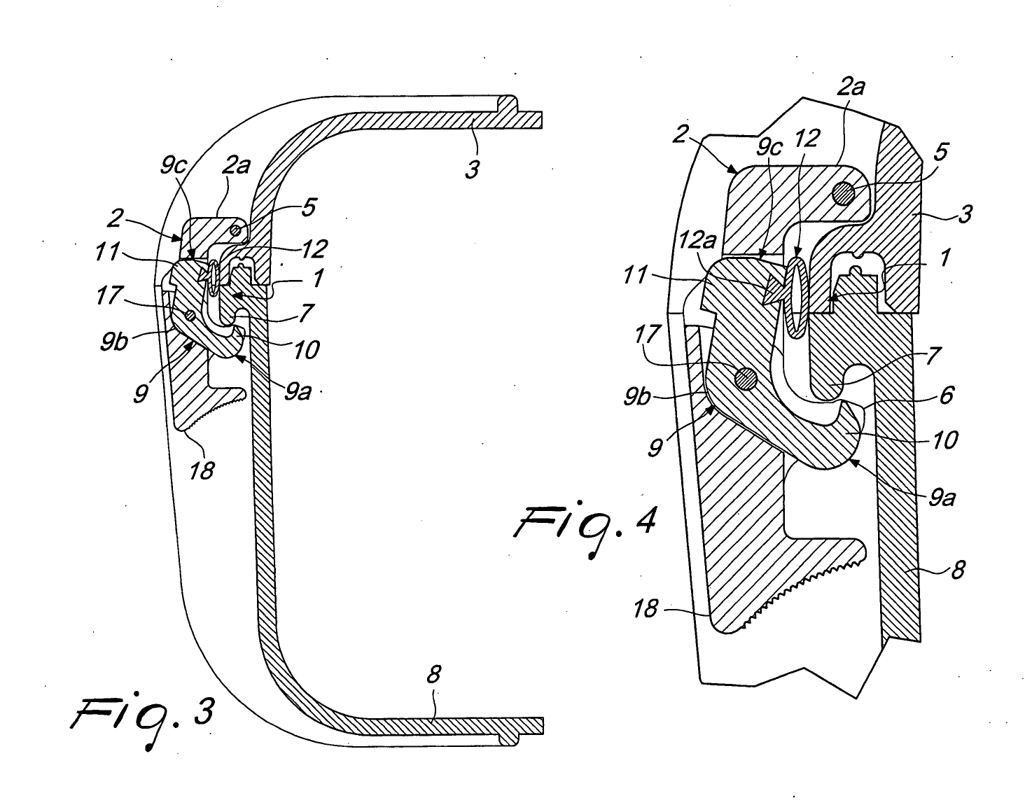

Conveniently, as shown in the embodiments illustrated in FIGS. 2 to 7, the clamp 2 has, on the opposite side with respect to the first end 2a, an extension 18, which is adapted to facilitate the manual grip of the clamp 2.

By gripping the extension 18 it is sufficient to apply a slight force to cause the rotation of the clamp 2 and therefore the release of the lock 1, and it is therefore extremely easy to pass from the closure configuration to the opening configuration of the suitcase 4.

According to alternative embodiments, which are in any case within the protective scope claimed herein, shown in FIGS. 1 and 8 to 13, the lock 1 according to the invention comprises a lever 19, which is articulated to the clamp 2 about a second pivot 20, which is associated rotatably with a second end 2b of the clamp 2, which lies opposite the first end 2a.

The lever 19 can be operated manually, at a grip region 21, optionally provided with a suitable knurling, which is formed on the opposite side with respect to the clamp 2, in order to move respective surface portions into abutment against corresponding shoulders formed on the clamp 2.

In this manner, by acting on the lever 19, it is possible to apply a torque that is adapted to cause the transition from the closure configuration to the opening configuration and vice versa.

With reference to the embodiments shown in the accompanying figures, the lever 19 is substantially U-shaped, having two ribs 22, 23 which are joined in a lower region by a crossmember 24. By acting therefore on the lever 19 in order to pass from the closure configuration to the opening configuration, a rotation is caused which moves the central regions 22a, 23a of the two ribs 22, 23 into abutment against respective surfaces 6a, 6b formed on the lip 6 (which in practice is constituted by two parts which are spaced by the recess 14). In this manner, the rotation of the clamp 2 and the release of the lock 1 are produced.

Vice versa, in order to pass from the opening configuration to the closure configuration, it is necessary to act on the lever 19 (obviously in the opposite direction with respect to the preceding one) in order to bring the free ends 22b, 23b into abutment against respective inclined planes 25, 26.

This action allows to apply a torque to the clamp 2 that causes its rotation to block the lock 1.

Conveniently, the lock 1 can comprise a blocking device, which can be activated and deactivated on command and is capable of contrasting the free rotation of the clamp 2 or of the arm 9 (or both).

This device, which might be constituted by a known type of padlock, which can be activated and deactivated by means of a key, prevents the opening of the suitcase 4 to anyone who does not possess the key, and therefore avoids the danger of unwanted accesses to the contents of the suitcase 4.

The use of the lock according to the invention is as follows.

FIGS. 5, 6, 11 and 12 illustrate the lock 1 in the closure configuration, in which the clamp 2 is rotated so as to engage elastically its lip 6 with the protrusion 7, thus mutually fastening the first half-shell 3 and the second half-shell 8.

In this closure configuration, in the absence of external interventions, fastening is reinforced by the arm 9, and particularly by the tab 10, which engages the protrusion 7 elastically.

In order to move the lock 1 from the closure configuration to the opening configuration, it is therefore necessary to work both on the clamp 2, optionally with the aid of the lever 19, and on the arm 9, by pressing the button 11.

More specifically, the suitcase 4 is opened by first pressing the button 11 (with a force of limited intensity) in order to turn the arm 9 and thus disengage the tab 10 from the protrusion 7.

At the end of this operation, the lock 1 is still in the closure configuration, but it is sufficient to apply a slight force to the clamp 2 to release the lock 1 and thus open the suitcase 4.

With respect to known solutions, accordingly the lock 1 according to the invention achieves the desired aim of ensuring greater tightness and resistance to impacts by way of the double coupling ensured by the clamp 2 and by the arm 9.

This functionality is not achieved by oversizing the clamp 2 and therefore does not compromise ease of manual opening.

In particular, it should be noted that by means of a suitable sizing it is possible to achieve a particularly stable and firm interlocking between the tab 10 and the protrusion 7, such as to ensure high resistance to impacts, while keeping small the force needed for disengagement by pressing the button 11.

At the same time, the sizing and shape of the lip 6 can be provided with the sole purpose of ensuring a weak safety coupling (in practice entrusting the stable closure function to the arm 9), thus avoiding the provision of a coupling that is difficult to remove.

In this regard, it is specified that the scope of the protection defined herein includes embodiments that have different mutual positions of the rotation axes of the articulation rod 5, of the first pivot 17 and of the second pivot 20.

The positioning of these axes in fact determines the forces and torques required to block and release the lock 1 and therefore contributes to control the ease or lack thereof of opening of the lock 1.

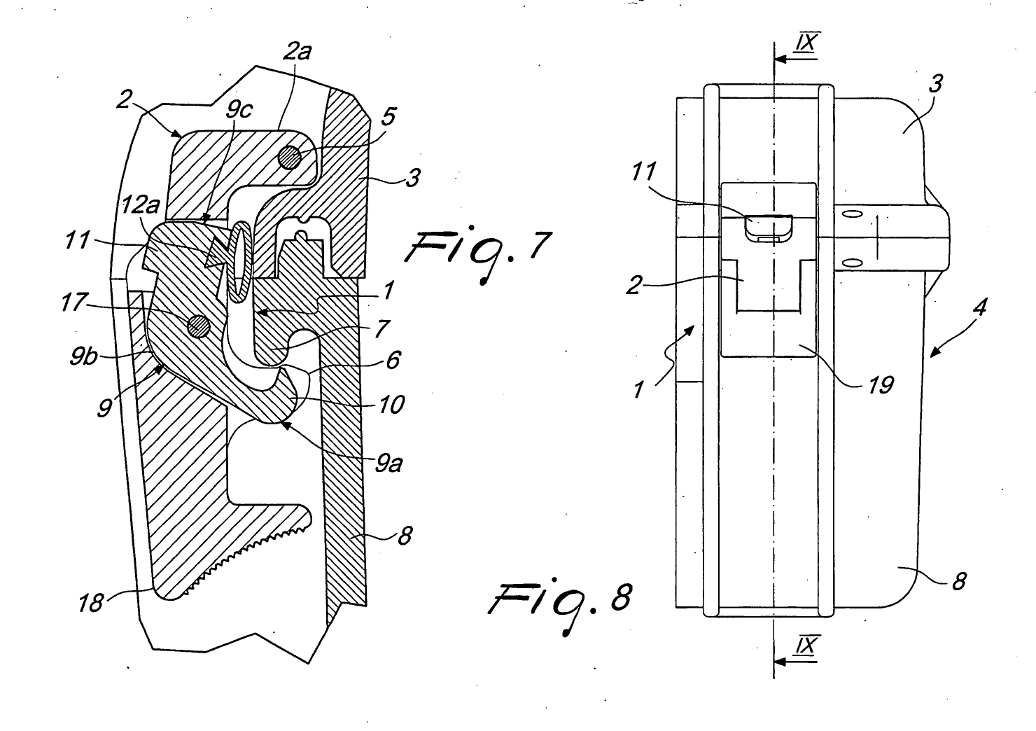

Different sizings of the components of the lock 1 according to the invention are also provided in the details shown in FIGS. 7 and 13, which illustrate different embodiments, which are in any case within the protective scope claimed herein of the lock 1.

Finally, it should be noted that the lock 1 according to the invention requires the presence, on the suitcase 4, of a simple folded edge that forms the protrusion 7, without providing other elements thereon.

Said edges are widespread on the suitcases 4 and on the trunks that are commercially available, thus allowing to apply the lock 1 according to the invention also to existing containers without requiring further interventions or modifications thereof.

In practice it has been found that the lock according to the invention fully achieves the intended aim, since resorting to an arm that is articulated to the clamp that fastens the first half-shell to the second half-shell of the suitcase allows to reinforce said fastening, in order to maintain the closure and hermetic seal even following accidental actions, without compromising practicality and ease of manual opening.

The invention thus conceived is susceptible of numerous modifications and variations, all of which are within the scope of the appended claims; all the details may further be replaced with other technically equivalent elements.

In the exemplary embodiments shown, individual characteristics, given in relation to specific examples, may actually be interchanged with other different characteristics that exist in other exemplary embodiments.

Moreover, it is noted that anything found to be already known during the patenting process is understood not to be claimed and to be the subject of a disclaimer.

In practice, the materials used, as well as the dimensions, may be any according to requirements and to the state of the art.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

1-8. (canceled)

9. A lock, particularly for suitcases and trunks, comprising at least one clamp which is articulated, substantially with a first end, to a first half-shell of a suitcase, said clamp being able to rotate from a closure configuration of the suitcase, in which a lip that protrudes from said clamp abuts elastically against a protrusion formed along a second half-shell of the suitcase, to fasten said first half-shell to said second half-shell, to an opening configuration of the suitcase, in which said lip is disengaged from said protrusion, and vice versa, further comprising an arm, which is articulated to said clamp and has, at a first end portion thereof, a curved tab that can engage elastically by interlocking with said protrusion at said closure configuration, in order to reinforce the fastening of said first half-shell to said second half-shell, said arm being manually actuatable to disengage said tab from said protrusion, independently of said clamp.

10. The lock according to claim 9, wherein said arm is articulated to said clamp substantially at a central portion thereof, the second end portion of said arm that lies opposite said first end portion being shaped substantially like a button, an elastically deformable element being interposed between said button and said first half-shell, the elastic reaction of said element moving said tab so that it engages automatically said protrusion at said closure configuration, an external pressure on said button, on the opposite side with respect to said element, with consequent elastic compression of the latter, causing the rotation of said arm about said central portion thereof for the disengagement of said tab from said protrusion.

11. The lock according to claim 10, wherein said elastically deformable element is substantially a spring, which has a protrusion whose shape is complementary to the shape of a receptacle formed on said second end portion, in order to fix it to the latter.

12. The lock according to claim 10, wherein said arm has, at said second end portion, a protrusion made of elastically deformable material, which constitutes said element.

13. The lock according to claim 10, wherein at least one central region of said clamp is provided with two lateral ribs that delimit a central recess, which forms a seat for said arm, said clamp further having, above said recess, a slot for accommodating said button, two holes for receiving a first pivot being provided along said ribs said pivot passing through said central portion of said arm for its articulation to said clamp.

14. The lock according to claim 9, wherein said clamp has, on an opposite side with respect to said first end, an extension that is adapted to facilitate the manual grip of said clamp to cause the release of said lock and the transition from said closure configuration to said opening configuration.

15. The lock according to claim 9, further comprising a lever, which is articulated to said clamp about a second pivot, which is associated rotatably with a second end of said clamp that lies opposite the first one, said lever being manually actuatable, at a grip region formed on an opposite side with respect to said clamp, in order to move respective surface portions into abutment against corresponding shoulders formed on said clamp by applying a torque that is adapted to cause a transition from said closure configuration to said opening configuration and vice versa.

16. The lock according to claim 9, further comprising a blocking device, which can be activated and deactivated on command and is adapted to contrast the free rotation of at least one between said clamp and said arm in order to prevent the opening of the suitcase.
